(19) United States
(12) Patent Application Publication
(10) Pub. No.: US 2008/0263615 A1
(43) Pub. Date: Oct. 23, 2008

(54) INTEGRATED OPERATION MANAGEMENT SYSTEM OF VIDEO TRANSMISSION NETWORK AND OPERATION MANAGEMENT METHOD

(75) Inventors: Shuntaro KASHIHARA, Saitama (JP); Kenichi OGAKI, Saitama (JP); Tomohiro OTANI, Saitama (JP)

Correspondence Address: OLIFF & BERRIDGE, PLC, P.O. BOX 320850, ALEXANDRIA, VA, 22320-4850, US

(73) Assignee: KDDI CORPORATION, Tokyo (JP)

(21) Appl. No.: 12/104,556

(22) Filed: Apr. 17, 2008

(30) Foreign Application Priority Data
Apr. 19, 2007 (JP) 2007-110262

(51) Int. Cl. H04N 7/173

(52) U.S. Cl. 725/127

(57) ABSTRACT

An integrated operation management system of video transmission network operates and manages a network connecting between video transmission equipments, said integrated operation management system comprises: a detection means for detecting said video transmission equipments and transmission equipments in said network; an information collection means for collecting equipment information about the video transmission equipments and the transmission equipments detected by said detection means, path information, link information, and configuration information about a video session between said video transmission equipments; a record means for recording said system information, said path information, said link information, and said configuration information about the video session with associated each other; and a failure specification means for specifying failure points or performance degradation points from failure notifications or performance degradation notifications notified from said network based on said associated and recorded information.

### PRIORITY CLAIM

This application claims priority from Japanese patent application No. 2007-110262, filed on Apr. 19, 2007, which is incorporated herein by reference.

### BACKGROUND OF THE INVENTION

1. Field of the Invention

The present invention relates to an integrated operation management system of video transmission network and an operation management method managing a video transmission equipment which transmits video data through an IP network. More specifically, the present invention relates to the integrated operation management system of video transmission network and the operation management method which rapidly specify failures or performance degradation points occurring in the video transmission equipment.

2. Description of the Related Art

A company has constructed WAN (Wide Area Network) between a head quarter and branch offices by using a leased line or a frame relay provided by telecommunications carriers in order to get higher reliability and in order to shorten transmission delay when the company transmits a video data. The leased line service lends users a closed communication path at constant charge.

However, in case of constructing the WAN by using the leased line or the frame relay, the user had to construct the system with considering communication capacity or efficiency. Further, since this system did not have flexibility against a traffic increase etc., the user needed a lot of costs for a system construction or maintenance.

Therefore, recently, IP-VPN (IP-Virtual Private Network) service and Wide Area Ethernet service which connect between remote bases with high speed and inexpensive price are just using as a communication infrastructure with safety and low cost instead of the leased line service. These services share backbone networks provided by the telecommunications carriers, and provide such a service (the VPN service) as the leased line for each use.

### SUMMARY OF THE INVENTION

However, the fact is that not all the VPN services are high quality network as the leased line and the quality of the VPN service degrades due to performance of network constitution equipments or a network traffic load.

As main reasons of the quality degradation of the VPN service, there is a routing process load or a buffering process load of routers, switches, bridges, etc., which construct the network. When the process loads increase, a transmission delay of the network occurs, or when the network traffic exceeds limit of the network assurance, some unprocessed packets may drop.

It is desirable that the video transmission network have a small variation of the transmission delay and do not drop the unprocessed packets for a high quality video transmission. If failures or performance degradation occurs on video transmission, it is desirable rapidly to specify the failure points or the performance degradation points and rapidly to recover. However, as it is now, an operation administrator separately detects failure notifications or performance degradation notifications from the video transmission equipments and various transmission equipments, then he or she must specify the failure points or the performance degradation points based on the above notifications. So, there is a problem that the operation management is difficult.

Therefore, it is an object of the present invention to provide an integrated operation management system of video transmission network and an operation management method which realize improvement in efficiency of an operation management by rapidly specifying failure points or performance degradation points in the video transmission network.

To realize above object, according to the present invention, an integrated operation management system of video transmission network which operates and manages a network connecting between video transmission equipments, said integrated operation management system comprising: a detection means for detecting said video transmission equipments and transmission equipments in said network; a information collection means for collecting equipment information about the video transmission equipments and the transmission equipments detected by said detection means, path information, link information, and configuration information about a video session between said video transmission equipments; a record means for recording said equipment information, said path information, said link information, and said configuration information about the video session with associated each other; and a failure specification means for specifying failure points or performance degradation points from failure notifications or performance degradation notifications notified from said network based on said associated and recorded information.

Further, it is also preferable that said integrated operation management system of video transmission network further comprises a display means for displaying said associated and recorded information with visualized.

Further, it is also preferable that said display means also displays said specified failure points or said specified performance degradation points with visualized.

Further, it is also preferable that said integrated operation management system of video transmission network further comprises a video management means for performing provisioning of the video session between said video transmission equipments by controlling said video transmission equipments.

Further, it is also preferable that said integrated operation management system of video transmission network performs the provisioning of the video session in which the failure occurs or the video session in which the performance degrades by said video management means if the failure points or the performance degradation points are specified by said failure specification means.

To realize above object, according to the present invention, an operation management method of a network connecting between video transmission equipments comprising: a detection step of detecting said video transmission equipments and transmission equipments in said network; a information collection step of collecting equipment information about the video transmission equipments and the transmission equipments detected by said detection step, path information, link information, and configuration information about a video session between said video transmission equipments; a record step of recording said equipment information, said path information, said link information, and said configuration information about the video session with associated each other; and a failure specification step of specifying failure points or performance degradation points from failure notifications or performance degradation notifications notified from said network based on said associated and recorded information.

According to the present invention, it is possible rapidly to specify the failure points or the performance degradation points in the video transmission network by saving multilayer information such as the video session between the video transmission equipments, MPLS (Multi protocol Label Switching) paths, links between transmission equipments into a database with associated each other. For this reason, this invention realizes improvement in efficiency of the operation management.

### BRIEF DESCRIPTION OF THE DRAWINGS

FIG. 1 shows a network diagram including the integrated operation management system of video transmission network according to the present invention;

FIG. 2 shows a multilayer on the network according to the present embodiment;

FIG. 3 shows a display example about a associated video session in the case of occurring a failure at a router in FIG. 2; and

FIG. 4 shows a display example about an associated video session in the case of occurring a failure at a MPLS path.

### DESCRIPTION OF THE PREFERRED EMBODIMENTS

An embodiment of the integrated operation management system of video transmission network according to the present invention will be described below with reference to the drawings.

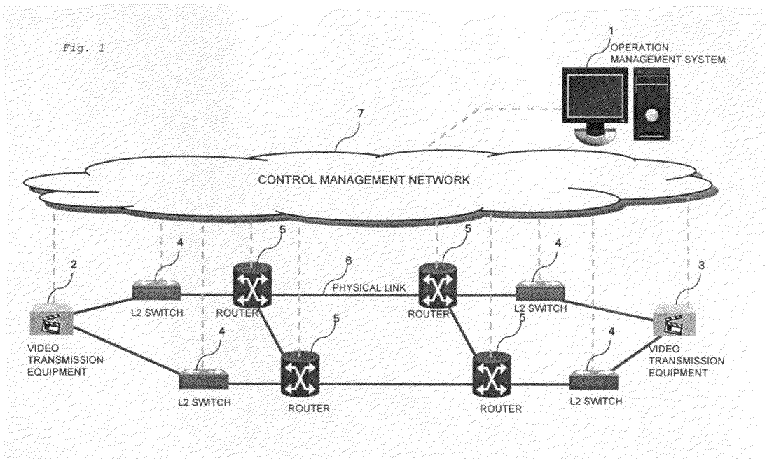

FIG. 1 shows a network diagram including the integrated operation management system of video transmission network according to the present invention. An operation management system 1 is a system to manage this network operation and corresponds the integrated operation management system of video transmission network of the present invention. A frame of video data is transmitted to a video transmission equipment 3 of the receiving end from a video transmission equipment 2 of the sending end. There are L2 switches 4 which transmit the frames based on information of a data link layer (L2) and routers 5 which transmit the frames based on information of a network layer (L3) in the network. Physical links 6 are provided between each equipment. Also, MPLS paths (not shown) are provided between the routers, and the video frames are transmitted by using MPLS between the routers. A routing protocol of the routers 5 is selectively used a static routing or a dynamic routing (for example, BGP4, Border Gateway Protocol version4). Each equipment in the network is connected to a control management network 7 (a control plane) to control and manage each equipment, and the operation management system 1 is connected to the control management network 7.

Further, as shown in FIG. 1, a path for the video transmission is constructed by a full redundant communication path. This ensures availability (reliability). Further, the L2 switches 4 which perform the routing process by hardware and the routers 5 which perform the label forwarding process by the MPLS ensure a QoS (Quality of service) such as throughput or transmission delay.

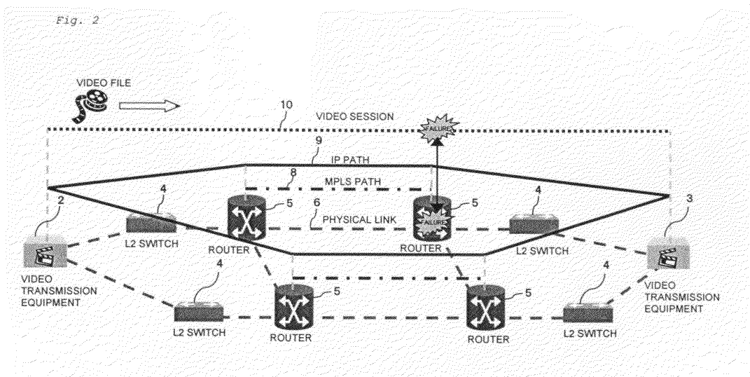

FIG. 2 shows a multilayer on the network according to the present embodiment. It is possible rapidly to specify failures or performance degradation points by managing multilayer information with associated each other.

The layer of this embodiment consists of four multilayers which are the physical links 6, the MPLS paths 8, IP paths 9, and a video session 10. The physical links 6 are shown by dashed lines and are provided between each equipment. The MPLS paths 8 are shown by dashed-dotted lines and are provided between the routers 5. The IP paths 9 are shown by solid lines and are provided between the video transmission equipment 2 and the video transmission equipment 3. Since the IP paths 9 are redundant, two paths are shown between the video transmission equipment 2 and the video transmission equipment 3. The video session 10 is shown by a dotted line and is provided between the video transmission equipment 2 and the video transmission equipment 3.

The operation management system 1 collects information from the multilayer of above network, and then saves the multilayer information into a database with associated each other. As an example of the multilayer information, the video session 10 layer has information about interfaces of the video transmission equipments 2 and 3, IP addresses, and the routers 5. The operation management system 1 specifies the failure points and the performance degradation points in the network based on this multilayer information.

For this reason, the operation management system 1 of the present invention has a topology management to determine a network topology and to collect various information. Further, the operation management system 1 also has a video session management to perform provisioning of the video session by controlling the video transmission equipment 2. Further, the operation management system 1 also has a failure detection to specify the failure points and the performance degradation points based on the multilayer information collected by the topology management. Further the operation management system 1 also has a display means to display the multilayer information collected by the topology management by GUI with visualized. The display means can also display the detected failure points and the detected performance degradation points with visualized. The topology management, the video session management, the failure detection, and the display means will be explained later in detail.

First, the topology management performs an equipment discovery, and then detects the video transmission equipments and transmission equipments in the network. The video transmission equipments and the transmission equipments were detected by SNMP (Simple Network Management Protocol) in principle. This is done by collecting management information from MIB (Management Information Base) as the operation management system 1 is a SNMP manager and the video transmission equipments and transmission equipments in the network are SNMP agents. However, information about the L2 switches 4 can collect from VLAN (Virtual LAN) address and information about the video transmission equipments 2 and 3 can be previously registered in the operation management system 1 manually.

Next, the operation management system 1 manages information about the MPLS paths 8, TE (Traffic Engineering) links, the physical links 6 with associated each other. The MPLS paths 8 are provided from an edge router to an edge router and are shown by dashed-dotted lines in FIG. 2. The TE links are traffic engineered links by the MPLS and are not shown in FIG. 2. The physical links 6 are links between the transmission equipments and shown by dashed lines in FIG. 2. Information about these paths and links is collected from the MIB information by the SNMP, and is saved into the database with associated each other. For example, the MPLS paths 8 are saved into the database with associated the physical links 6 which the MPLS paths 8 consist of.

Next, the operation management system 1 collects configuration information to manage the video session 10, which is shown by a dotted line in FIG. 2, provided between the video transmission equipments. This information is also collected from the MIB information by the SNMP. Also, this information can be collected by the operation management system 1 logging in the video transmission equipment 2 using telnet or etc. In this embodiment, the configuration information is the IP address of the video transmission equipment 3 of the receiving end. The operation management system 1 specifies the video transmission equipments which are both ends of the video session 10 based on this configuration information, and saves the collected video session information into the database.

By the information about the transmission equipments, the information about the paths and links, the information about the video transmission equipments, and the configuration information about the video session, it is possible to display the associated information etc. by GUI with visualized. For example, after associated the MPLS paths 8 and the video session 10, from the video session 10, it is possible to display the information about the MPLS paths 8 which corresponds the video session 10.

In the video session management, the control of the video transmission equipments is performed by using the video transmission equipment 2 of the sending end, the video transmission equipment 3 of the receiving end, the using MPLS paths 8, which are elements of the video session 10, and a delay variation. The delay variation about the video session 10 can be detected by measuring a variation of arrival time of the video frame.

The operation management system 1 controls the video transmission equipment and performs the provisioning of the video session 2 by using SNMP, HTTP, telnet, etc. Specifically, by assigning IP address of the video transmission equipment 3 of the receiving end and a transmission rate to the video transmission equipment 2 of the sending end, the MPLS path 8 provided between the video transmission equipments and the video session 10 are associated on one-to-one relation. Further, when the video session 10 is deleted, the associated MPLS path 8 is deleted. Further, if the delay variation about the video session 10 is large, the operation management system 1 can change over the physical path of the MPLS path 8.

The failure detection is performed by the operation management system 1 collecting the failure information. The failure of the L2 switches 4, the routers 5, and interface of these equipments, the failure of the MPLS paths 8, the failure of the video transmission equipments 2 and 3, and the delay variation about the video session 10 can be collected by a trap of the SNMP. Further, the information about the failure which no trap of the SNMP occurs can be collected by the operation management system 1 periodically monitoring the health and status of each equipment using ping or telnet.

The failure information collected as above is associated with the information saved into the database. For example, in case of occurring a failure at the router 5, a failure notification about the router 5, a failure notification about the MPLS path 8 which uses the router 5, and a failure notification about the video session 10 corresponding to the MPLS path 8 are reported by the trap of the SNMP. Since the router 5, the MPLS path 8, and the video session 10, which report these failure notifications, are associated with each other by the information saved into the database, it is found that the failure point is the router 5 and other failure notifications are failure notifications due to the failure of the router 5.

Above explained, an operation administrator need not separately detect failure notifications of the video transmission equipments and various transmission equipments, and need not specify the failure points or the performance degradation points based on these information. For this reason, the efficiency of the operation management improves.

Further, it is possible to specify the video session 10 associated with the router 5 at which the failure occurs by the database. After specified the video session 10, by the video session management changing over the physical path of the MPLS path 8 using the other normal router 5 so as to bypass the failure point, a recovery from the failure is rapidly performed.

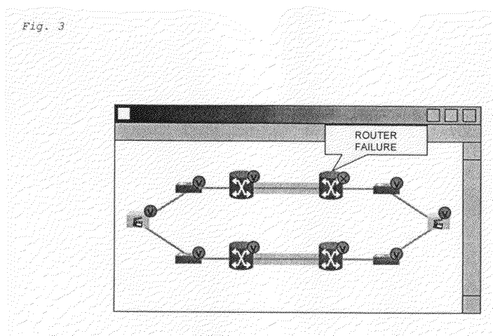

The above failure information can be displayed with visualizing by the GUI. FIG. 3 shows a display example about an associated video session in the case of occurring a failure at a router 5 in FIG. 2. The equipment displayed “V” shows normal and the equipment displayed “X” shows that the failure occurs in this equipment. In this manner, it is possible to specify the failure point in the network. In this figure, although only one video session 10 is displayed, a plurality of video sessions 10 are displayed if the router 5 at which the failure occurs is used in a plurality of the video sessions 10.

Further, in case of the failure of the router 5, since the path is redundant, the video frame is transmitted through a normal path. So, the video sessions 10 can transmit the video frame. However, since the redundancy has lost, the availability is decreased. Therefore, the operation management system 1 changes over the physical path of the MPLS path 8 so as to bypass the failure point and can increase the availability by constructing a redundant path again. In this manner, it is possible to specify the other portion which reaches the failure. For this reason, the efficiency of the operation management improves.

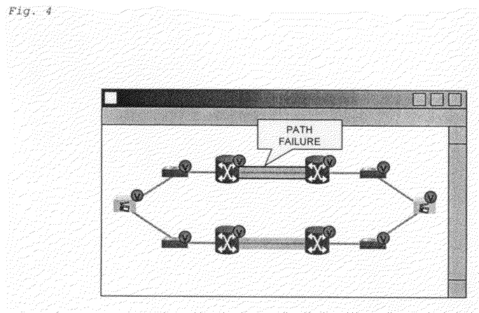

FIG. 4 shows a display example about an associated video session in the case of occurring a failure at a MPLS path 8. As the MPLS path 8 is displayed thick, it is possible to specify the MPLS path 8 at which the failure occurs. In this embodiment, the operation management system 1 also changes over the physical path of the MPLS path 8 so as to bypass the failure point and can increase the availability by constructing redundant path again.

Although it was explained above that the failure occurred at the routers 5 or the MPLS paths 8, the case that the performance degradation occurs is the same. For example, in case of occurring the performance degradation at the router 5, although performance degradation notifications are reported from the associated MPLS path 8 and video session 10 as well as the failure case, the operation management system 1 can specify that the router 5 causes the performance degradation based on the information saved into the database. In this case, as shown in FIG. 3, the operation management system 1 displays that the performance degradation point is the router 5, and can specify a search point for performance degradation. Therefore, since it is easy to ascertain a cause of the performance degradation, the efficiency of the operation management improves.

All the foregoing embodiments are by way of example of the present invention only and not intended to be limiting, and many widely different alternations and modifications of the present invention may be constructed without departing from the spirit and scope of the present invention. Accordingly, the present invention is limited only as defined in the following claims and equivalents thereto.

1. An integrated operation management system of video transmission network which operates and manages a network connecting between video transmission equipments, said integrated operation management system comprising:
a detection means for detecting said video transmission equipments and transmission equipments in said network;
an information collection means for collecting equipment information about the video transmission equipments and the transmission equipments detected by said detection means, path information, link information, and configuration information about a video session between said video transmission equipments;
a record means for recording said equipment information, said path information, said link information, and said configuration information about the video session with associated each other; and
a failure specification means for specifying failure points or performance degradation points from failure notifications or performance degradation notifications notified from said network based on said associated and recorded information.

2. The integrated operation management system of video transmission network according to claim 1, where in said integrated operation management system of video transmission network further comprises a display means for displaying said associated and recorded information with visualized.

3. The integrated operation management system of video transmission network according to claim 2, where in said display means also displays said specified failure points or said specified performance degradation points with visualized.

4. The integrated operation management system of video transmission network according to claim 1, where in said integrated operation management system of video transmission network further comprises a video management means for performing provisioning of the video session between said video transmission equipments by controlling said video transmission equipments.

5. The integrated operation management system of video transmission network according to claim 1, where in said integrated operation management system of video transmission network performs the provisioning of the video session in which the failure occurs or the video session in which the performance degrades by said video management means if the failure points or the performance degradation points are specified by said failure specification means.

6. An operation management method of a network connecting between video transmission equipments comprising:
a detection step of detecting said video transmission equipments and transmission equipments in said network;
an information collection step of collecting system information about the video transmission equipments and the transmission equipments detected by said detection step, path information, link information, and configuration information about video session between said video transmission equipments;
a record step of recording said system information, said path information, said link information, and said configuration information about the video session with associated each other; and
a failure specification step of specifying failure points or performance degradation points from failure notifications or performance degradation notifications notified from said network based on said associated and recorded information.
